(19) United States
(12) Patent Application Publication
(10) Pub. No.: US 2014/0091026 A1
(43) Pub. Date: Apr. 3, 2014

(54) FILTER APPARATUS FOR AN INTERNAL COMBUSTION ENGINE

(71) Applicants: Oliver Lambert, Stuttgart (DE); Carlos Hollnagel, Winnenden (DE); Jason E. Martin, Livonia (DE)

(72) Inventors: Oliver Lambert, Stuttgart (DE); Carlos Hollnagel, Winnenden (DE); Jason E. Martin, Livonia (DE)

(21) Appl. No.: 13/629,663

(22) Filed: Sep. 28, 2012

(51) Int. Cl. B01D 29/92; B01D 35/30

(52) U.S. Cl. CPC B01D 29/92; B01D 35/30
USPC 210/232; 210/418

(57) ABSTRACT

In a filter arrangement for filtering the fuel, of an internal combustion engine including a housing accommodating a filter element and having at the bottom thereof a collection space for collecting water removed from the fuel, a drain passage extends from the collection space at an angle with respect to a vertical line and a vent channel is disposed in the filter housing wall and extends to the drain passage permitting air to enter when water is drained from the collection space upon opening a drain valve which is disposed in the drain passage.

### BACKGROUND OF THE INVENTION

The invention resides in a filter arrangement for filtering a liquid fuel of an internal combustion engine including a housing accommodating a filter element with a collecting space for collecting water removed from the liquid and a drain element for removing the water from the collecting space and a valve element for controlling the release of the water from the collecting space via a drain passage.

Such a filter arrangement is known for example from DE 103 22 555 A1. Herein, the filter arrangement is a fuel filter and the liquid being filtered is fuel. The filter arrangement (fuel filter) comprises a housing which includes an accommodation space for at least one filter element for filtering the liquid (fuel). In addition the housing includes vertically below the fuel filter accommodation space a collection space. The collection space is provided for collecting water which is separated from the liquid during filtering of the fuel.

The filter arrangement comprises a release element which has a drain passage which includes a section that extends at an angle to a vertical direction and opens into the collection space. The drain passage serves for the removal of the water from the collection space.

There is also a valve element which is adjustable between a blocking position and an open release position. In the blocking position, the drain passage is blocked by the valve element to prevent water from flowing out of the collection space. In the release position, the drain passage is at least partially open so that water can flow out of the collection space via the drain passage. The valve element is, at least in its blocking position, at least partially in the part of the drain passage which is inclined with respect to a vertical line. It has been found however that during the discharge of the water from the collection space the water flow out of the collection space as not satisfactory because of adverse pressure conditions.

EP 1 544 453 A1 discloses a filter arrangement in the form of a fuel filter with a valve arrangement for releasing water from a housing of the filter arrangement. The housing has at one side thereof a depression with a discharge opening. Via the discharge opening water can be released from the housing. In the discharge opening area, a cylindrical bore is provided which extends into the discharge opening and in which a valve element is installed for blocking and at least partially opening the discharge opening. This fuel filter however is quite complex and requires a large installation space.

It is therefore the object of the present invention to provide a filter arrangement of the type described above which however provides for a particularly advantageous release of the water from the collection space and which can be realized in a simple and uncomplicated manner while requiring only a small installation space.

### SUMMARY OF THE INVENTION

In a filter arrangement for filtering the fuel of an internal combustion engine including a housing accommodating a filter element and having at the bottom thereof a collection space for collecting water removed from the fuel, a drain passage extends from the collection space at an angle with respect to a vertical line and a vent channel is disposed in the filter housing wall and extends to the drain passage permitting air to enter when water is drained from the collection space upon opening a drain valve which is disposed in the drain passage.

In other words means are provided by which, during the draining of the water from the collection space via the drain passage ambient air is permitted to flow via the venting channel into the collection space. In this way, unfavorable pressure conditions such as a vacuum or low pressure in the collection space which inhibit a water flow through the drain passage are avoided. With the integration of the venting channel into the wall which delimits at least partially also the drain passage, the venting of the collection space is achieved in a simple space-saving manner. The wall thereby has a double function, since, on one hand, it delimits the drain passage and on the other also the venting channel. In this way, also the space requirements and the manufacturing expenses for manufacturing the housing are kept particularly low.

The filter arrangement according to the invention also provides for very advantageous handling in particular for the draining of the water from the collection space. Because of the orientation of the drain passage at an angle to the vertical line, the valve element may also be oriented at an angle to the vertical line so that the valve element of the filter arrangement, which is installed for example in an engine compartment, is easily reachable and easy to operate.

In particular in contrast to filter arrangements, wherein the drain passage extends vertically and wherein also the valve element is oriented accordingly, the valve element of the filter element according to the invention has an outer contour which is inclined and projects sidewardly so that it is not covered by other components arranged in the engine compartment.

In this way, the valve is ergonomically activatable for adjusting it between an open and a closed position. The valve is adjusted for example by rotation of an operating element about an axis of rotation which, because of the advantageous accessibility of the valve element can be performed ergonomically. Because of the orientation and the resulting accessibility the operating element can be grasped by a person.

To provide for a particularly advantageous venting of the collection space, in a particularly advantageous embodiment of the invention the venting channel is arranged in the inclined section of the drain passage. Preferably, the drain passage extends at an acute angle with respect to a vertical line and the venting channel for providing a particularly advantageous venting is arranged within the acute angle area.

In a further advantageous embodiment of the invention, the drain passage has a discharge opening via which the water flowing through the drain passage is drained from the collection space, and which is arranged at one end of the inclined section. This means that the water flowing through the drain passage which is inclined with respect to a vertical line leaves the drain passage at an angle. In this way, the water collected can be conducted away from the filter arrangement in a particularly advantageous manner since the drain passage. is easily accessible.

For providing a particularly advantageous accessibility and operability of the valve element, in another embodiment of the invention, the valve element in its closed position projects partially beyond the discharge opening of the drain passage.

It has further been found to be particularly advantageous if the venting channel extends inclined or normal to drain passage. In this way, the air from the area surrounding the collection space can enter without detrimentally affecting or disturbing the water flow out of the collection space.

In another advantageous embodiment of the invention, the air venting channel is arranged in the vertically upper half of the drain passage. This upper half refers to an area of a flow cross-section of the drain passage through which the water can flow, to the volume of the drain passage or to the extension or the discharged passage in vertical direction of the filter arrangement. Because of the inclination of the partial area, the water flows upon opening of the valve element in the lower area of the drain passage while the air can flow in the upper half of the drain passage and reach the collection space in this way. As a result, the air flow does not obstruct the water flow out of the drain passage nor can the water reach the ambient undesirably is the venting channel.

It has been found to be particularly advantageous if the venting channel includes at least in some part thereof a protective element which includes an air guide passage through which air can flow and which extends to the drain passage. By means of this protective element, the venting channel can be protected from being soiled by particles or deposits so that a blockage of the air venting channel can be prevented. In addition, the protective element can prevent water from flowing via the air vent channel unwanted to the ambient.

In a further advantageous embodiment, the venting channel has at least a first channel area and a second channel area which is in communication with the first channel, area and extends at an angle or normal to the first channel area. In this way, it can be prevented or made unlikely that, upon opening of the valve element, the water is discharged to the ambient via the venting channel.

In a further embodiment of the invention, the air venting channel joins the water drain passage via at least two separate, spaced outlet openings which have an air flow cross-section which is smaller than the air flow cross-section of the common air vent channel. On one hand, the air can enter the collection space in this way particularly well via the air vent channel. On the other hand, the chances that the water flows out of the collection space via the very small outlet openings of the air vent channel end air vent channel to the ambient are very small.

For achieving a particularly simple installation of the protective element at the discharge element and in the venting channel, in a further embodiment of the invention the protective element is connected to the discharge element by means of a snap-on arrangement. In this way, the protective element can easily be removed and cleaned or replaced if it is soiled or blocked.

Further advantages and features of the invention will become apparent from the following description of a preferred embodiment of the invention with references to the accompanying drawings. The features described above or in the following description are usable not only in the described combination but also in other combinations or alone without departing the concept of the invention.

### BRIEF DESCRIPTION OF THE DRAWINGS

FIG. 1 shows schematically, in a sectional perspective view, a filter arrangement for an internal combustion engine of a motor vehicle, including a housing with a collection space for collecting water wherein the collection space has a drain passage for draining the collected water and wherein a wall area of the filter arrangement delimiting the drain passage at least partially includes a vent, channel, via which the collection space can be vented by ambient air during the draining of the water from the collection space.

FIG. 2 is a perspective view of a section of an engine compartment of the motor vehicle where the filter arrangement is installed;

FIG. 3 is a perspective view showing the filter arrangement partially cut;

FIG. 4 is another perspective view of the filter arrangement, and

FIG. 5 is a perspective view of a protective element for installation in part of the vent channel

### DESCRIPTION OF A PARTICULAR EMBODIMENT OF THE INVENTION

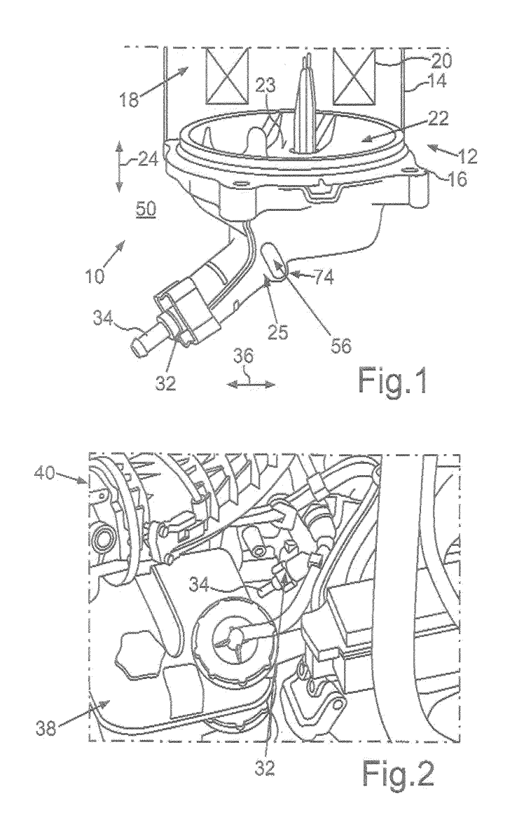

FIG. 1 shows a section of a filter arrangement 10, that is, a fuel filter of an internal combustion engine of a motor vehicle. The filter arrangement 10 serves as a filter for a liquid, specifically of liquid fuel by which the internal combustion engine is operated. The filter arrangement 10 comprises a housing 12 of which only a section is shown in FIG. 1 and which has an upper housing element 14 and a lower housing element 16. The housing elements 14, 16 are releasably interconnected. The housing 12 includes an accommodation space 18 in which a filter element 20 for filtering the liquid (fuel) of the internal combustion engine is at least partially accommodated and which is only schematically shown in FIG. 1. The housing 12 also includes a collection space 22 which is indicated in FIG. 1 by a directional arrow 24 and which is arranged in the vertical direction of the filter arrangement 10 below the accommodation space 18.

The collection space 22 is provided for collecting water which is removed from the fuel during filtering thereof by the filter element 20. Because its, in comparison with the fuel, higher density the water settles at the bottom and is collected in the collection space 22 at the lowest point of the housing 12. Since during operation of the internal combustion engine, the collection space is being filled with water, a removal, or, respectively, draining of the water from the collection space is necessary from time to time.

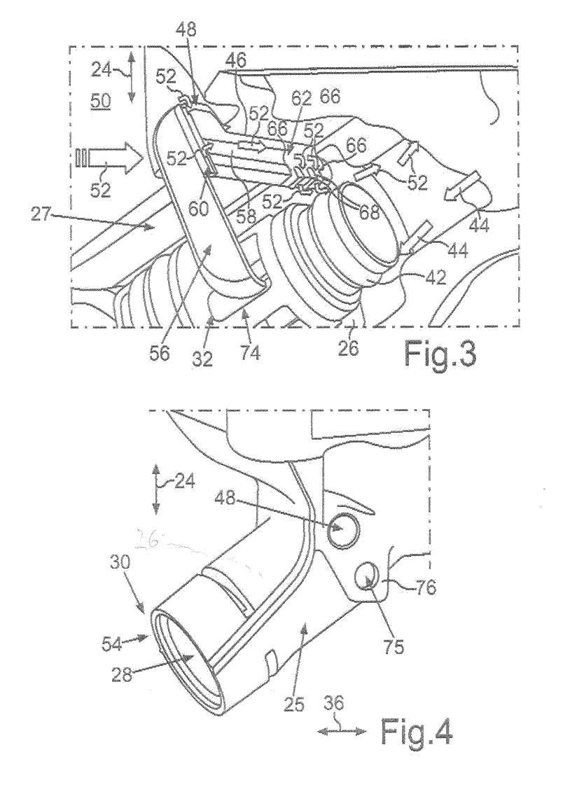

To this end, the filter element 10 is provided with a discharge or drain element 25. As apparent in connection with FIG. 3, the discharge element 25 includes a drain passage 26 which is in communication at one end thereof with the collection space 22 and which at its other end, has a discharge opening 28 as apparent in connection with FIG. 4. Herein the drain passage 26 extends at least in a partial area 27 which is inclined with respect to the vertical direction of the filter arrangement 10 as indicated by the directional arrow 24, wherein the discharge opening 20 is arranged in the partial areas 27 at one end 30 of the drain passage 26.

The filter arrangement 10 further comprises a valve element 32 which is adjustable between a position in which it blocks the drain passage fluidically and a release position in which the drain passage is at least partially open. The valve element 32 is provided with a connecting stub 34 to which a guide element for example a hose can be connected.

When the valve element 32 is moved from its blocking position to its open position, that is when it is opened, the water from the collection space 22 can flow through the drain passage 26 and flow from the drain passage 26 via the discharge opening 28 and via the connection stub 34 into the duct element or hose. Via the duct element, the collected water can then be removed from the filter arrangement 10.

As shown in FIG. 3, the valve element 32 as shown in FIG. 3 in its open position as well as in its closed position is accommodated at least partially in the part, area of the drain passage 26 which is inclined with respect to the vertical direction and extends from the drain passage 26 beyond the discharge opening 28.

As apparent also from FIGS. 1 and 4 the drain passage 26 is, at least in its partial area 27 or as shown over its full length inclined by a predetermined angle with respect to the vertical direction of the filter arrangement 10 so that the drain passage 26 extends with respect to the vertical direction at an angle of between 90° and 0°. Preferably, the drain passage 24 extends at an acute angle with respect to the vertical direction. The valve element 32 therefore can extend on the side beyond the housing 12 that is in a transverse direction of the filter housing 10 as indicated by a direction arrow 36, so that it is disposed partially at a side of the housing 12 or the housing element 16 and is not covered in the vertical direction fully by the housing 12.

FIG. 2 shows an engine compartment 38 of the motor vehicle in which the internal combustion engine (which is not visible), a multitude of components 40 of the motor vehicle as well as the filter arrangement 10 (which only partially shown) are arranged. As shown in FIG. 2, the respective orientation of the drain passage 26 and the resulting direction of the valve element 32 have the effect that the valve element 32 is not completely covered by components disposed in the engine compartment 38 adjacent the filter arrangement 10. As a result, the valve element is relatively easily accessible so that the duct element can be connected to the connection stub 34 without the need to uninstall the filter arrangement 10 or another component of the engine compartment 38. In addition, the valve element 32 can be easily grasped by a person and adjusted between its open and closed positions.

In particular because of the orientation of the drain passage 26 and the valve element 32, the valve element 32 is accessible from above. In the present case, the valve element 32 is adjusted by rotation of an operating element between an open and a closed position wherein such rotation can be performed ergonomically because of the good accessibility of the valve element 32.

FIG. 3 shows a seal element in the form of a seal ring 42 by means of which the drain passage 26 is blocked in the closed position of the valve element 32. Furthermore, FIG. 3 shows directional arrows 44 which indicate the flow of water out of the collection chamber 22 into the drain passage. and through the drain passage.

FIG. 3 also shows that a wall 46 of the housing element 16 which partially delimits the drain passage 26 is provided with a vent channel 48 via which air from the surroundings 50 of the filter arrangement can be supplied to the collection space during draining of the water. In other words, air from the surrounding 50 of the filter can flow through the vent channel 48 and into the collection space 22 when the valve element 32 is open. The vent channel 48 is arranged for example between the valve element 32 and a bottom 23 of the housing delimiting the collection space in vertical direction at the bottom 23 of the housing element 16.

The vent channel 48 is arranged in the partial area 27 of the drain passage 26, which extends at an angle to the vertical direction (direction arrow 24) so that the air flow into the collection space 22 and the water flow out of the collection space do not interfere.

In order to keep the travel distance of the air from the ambient 50 into the collection space 22 small the vent channel 48 ends shortly ahead of the seal ring 42 that is with respect to flow direction of the water out of the collection space 22 just downstream of the seal ring 42. The vent channel 48 is arranged in the upper half 54 of the drain passage 26 (FIG. 4). This raised arrangement facilitates that the water and the air do not impede each other since the water flows in the lower part of the drain passage 26 whereas the air flows in the to part of the drain passage 26 above the water into the collection space. Here the different densities of water and air are utilized.

By means of this venting of the collection space 22 which is achieved in a simple, space saving and inexpensive way by integration of the vent channel into the wall 46, a low pressure or vacuum in the collection space 22 which would detrimentally affect the outflow of the water from the collection space can be avoided. The water can therefore be drained from the collection space 22 within a short period.

As further shown in FIG. 3, the vent channel 48 extends essentially normal to the drain passage 26 so that the air can flow particularly well into the drain passage 26 and via the drain passage into the collection space 22.

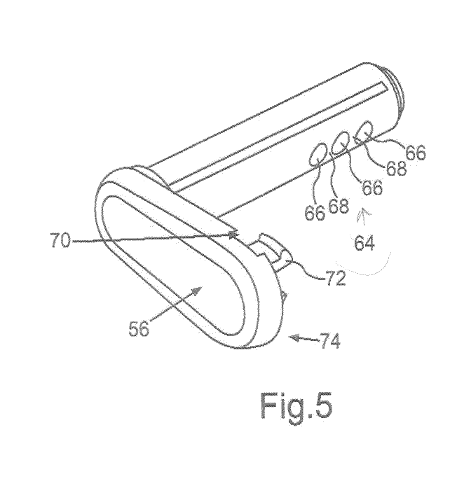

In order to avoid the ingestion of dirt, particles and/or similar contamination into the vent channel 48 or to keep the chances for contamination small, in the perspective representation of FIG. 5 a protective element 56 of the filter element 10 is shown which is partly inserted into the vent channel 48 and includes an air guide channel 58 through which the air will flow. The air guide channel 58 comprises a first longitudinal section 60 as well as a second longitudinal section 62 which are interconnected in communication with each other. The ambient air entering the longitudinal section 62 can flow into the longitudinal section 62. The two longitudinal sections 60, 62 extend normal to one another.

To protect the vent channel 48 effectively from the ingestion of dirt, particles and other contamination the protective element 56, when disposed partially in the vent channel 48, has a partial area 74 which is arranged outside the vent channel 48 and is in the form of a protective cover element.

The protective element 56 accommodated in the vent channel acts as a barrier and on one hand protects the valve element 32 and particularly the seal ring 42 thereof from dirt and damages caused thereby. On the other hand, the protective element 56 prevents water to flow out of the collection space 22 into the vent channel 48 and via the vent channel 48 to the ambient 50.

In the area 64, the protective element 56 is provided with outlet openings 66 which are separated from one another intermediate wall areas 68 and via which the vent channel 58 joins the drain passage 26. The outlet openings 66 have an opening cross-section for the air flow which is smaller than the flow cross-section of the air guide channel 58 which is common to the outlet openings 66. In other words: the air can flow from the air guide channel 58 via the outlet openings 66 into the drain passage 66. In this way, the chances that water flows from the collection space 22 via the small outlet openings 66 into the air guide channel 58 are very small.

FIG. 5 also shows an air inlet area 70 of the protective element 56 via which the air of the surrounding 50 can flow into the air guide channel 58. Furthermore, the protective element 56 includes a locking element 72, here in the form of an engagement projection, by means of which it can easily be connected to the drain element 25 via a snap-in connection. To this end, the drain element 25 includes an accommodation opening 75 corresponding to the locking element 72. A wall area 76 of the drain element delimiting the accommodation opening 75 acts herein as engagement structure which corresponds to the locking element 72 and with which the locking element is interlocked for forming the snap-in engagement.

In other words, the locking element 72 can be locked to the wall area 76. The locking element 72 permits also an orientation or, respectively, positioning of the protective element 56 relative to the housing element 16 in such a way that, upon installation on the housing element 16, the protective element 56 is oriented in an advantageous and predetermined installation position and is fixed in that position.

What is claimed is:

1. A filter arrangement (10) for filtering a liquid of an internal combustion engine baying a housing (12) with an accommodation space (18) for at least one filter element (20) for filtering the liquid and a collection space (22) disposed vertically below the accommodation space (18) for collecting water removed from the liquid during the filtering thereof, a drain element (25) with at least one drain passage (26) extending at least in a partial area (27) inclined with respect to a vertical direction (24) and extending from the collection space (22) for draining the collected water from the collection space (22), a valve, element (32) which is adjust able between a blocking position in which the drain passage (26) is closed and an open position in which the drain passage is at least partially open and which is accommodated to its closed position at least partially in the partial area (27) of the drain passage (26), the drain passage (26) being formed partially by a well (46) of the filter arrangement (10) and including a vent channel (48) via which ambient air is supplied to the collection space (22) for venting the collection space (22) during draining of the water from the collection space (22).

2. The filter arrangement according to claim 1, wherein the vent channel (48) is arranged in the partial area (27) of the drain passage (26) which extends inclined to the vertical direction (24).

3. The filter arrangement according to claim 1, wherein the drain passage (26) has a discharge opening (28) via which the water drained from the collection space (22) flows out of the drain passage (26) during draining of the water, and which is arranged at the end of the partial area (27) which extends inclined to the vertical directions (24).

4. The filter arrangement according to claim 3, wherein the valve element (32) which is at least partially accommodated in the partial area (27) projects in its blocking position partially from the discharge opening (28).

5. The filter arrangement according to claim 1, wherein the vent channel (48) extends at an angle or normal to the drain passage (26).

6. The filter arrangement according to claim 1, wherein the vent channel (48) is arranged in the vertical direction (28) of the filter arrangement (10) in an upper half (54) of the drain passage (26).

7. The filter arrangement according to claim 1, wherein a protective element (56) is at least partially accommodated in the vent channel (48) and includes an air guide channel (58) through which the air flows and which leads to the drain passage (26).

8. The filter arrangement according to claim 7, wherein the air guide channel (58) includes at least a first channel section (60) and a second channel, section (62) which is in communication with the first channel section (42) and extends at an angle, or normal, to the first channel section (60).

9. The filter arrangement according to claim 7, wherein the air guide channel (58) is in communication with the drain passage (26) via at least two spaced outlet openings (66) which each have an opening cross-section through which air flows and which is smaller than the air flow cross-section of the air guide channel (58).

10. The filter arrangement according to claim 7, wherein the protective element (56) is connected to the drain passage (26) by means of a snap-in engagement structure.
